(19) United States
(12) Patent Application Publication
(10) Pub. No.: US 2008/0296348 A1
(43) Pub. Date: Dec. 4, 2008

(54) Heater for select solder machine

(76) Inventors: Richard F. Slater, JR., Owego, NY (US); James S. Kamperman, Endwell, NY (US); John J. Lavetsky, Warrington, PA (US)

Correspondence Address: Michael Best & Friedrich;Casimir F. Laska, Suite 3300, 100 East Wisconsin Avenue, Milwaukee, WI, 53202-4108, US

(21) Appl. No.: 11/809,946

(22) Filed: Jun. 4, 2007

(51) Int. Cl. B23K 1/00; B23K 31/12

(52) U.S. Cl. 228/104; 228/262.9; 228/41; 228/57; 228/9

(57) ABSTRACT

A select solder machine configured to solder a circuit board using a solder material. The select solder machine includes a solder head movable with respect to the circuit board. The solder head is configured to position the solder material with respect to the circuit board to solder the circuit board. The select solder machine further includes a support member configured to support the circuit board in a position adjacent the solder head, and a heating member configured to heat the circuit board. The heating member is located above the circuit board.

### BACKGROUND

The present invention relates to solder machines, and more particularly to heaters for solder machines.

Solder machines are often used to solder electronic components of circuit boards to the boards or substrates. One type of solder machine that can be used to solder circuit boards is a wave or flow solder machine. A wave or flow solder machine creates a wave of molten solder material and the circuit board is passed over the wave using a conveyor. The bottom of the circuit board contacts the wave of molten solder, thereby soldering the electronic components of the circuit board. In another type of flow solder machine, known as a select solder machine, the circuit board is typically held in a fixed position and a movable solder head is used to move a stream of molten solder with respect to the circuit board to selectively solder electronic components to the circuit board.

### SUMMARY

In one embodiment, the invention provides a select solder machine configured to solder a circuit board using a solder material. The select solder machine includes a solder head movable with respect to the circuit board. The solder head is configured to position the solder material with respect to the circuit board to solder the circuit board. The select solder machine further includes a support member configured to support the circuit board in a position adjacent the solder head, and a heating member configured to heat the circuit board both before and during soldering. The heating member is located above the circuit board.

In another embodiment, the invention provides a select solder machine configured to solder a circuit board using a solder material. The select solder machine includes a housing, a circuit board support member configured to support the circuit board in a generally fixed position with respect to the housing, and a solder head located below the position of the circuit board. The select solder machine further includes a heating member configured to heat the circuit board both before and during soldering. The heating member is located above the position of the circuit board.

Other aspects of the invention will become apparent by consideration of the detailed description and accompanying drawings.

### BRIEF DESCRIPTION OF THE DRAWINGS

FIG. 1 is a perspective view of a select solder machine and a heater assembly embodying the present invention.

FIG. 2 is a perspective view of the heater assembly of FIG. 1.

FIG. 3 is a perspective view of a portion of the select solder machine and the heater assembly illustrating a cover of the solder machine in an open position.

FIG. 4 is a cross-sectional view of a portion of the select solder machine and the heater assembly taken along line 4-4 of FIG. 3 with the cover in a closed position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

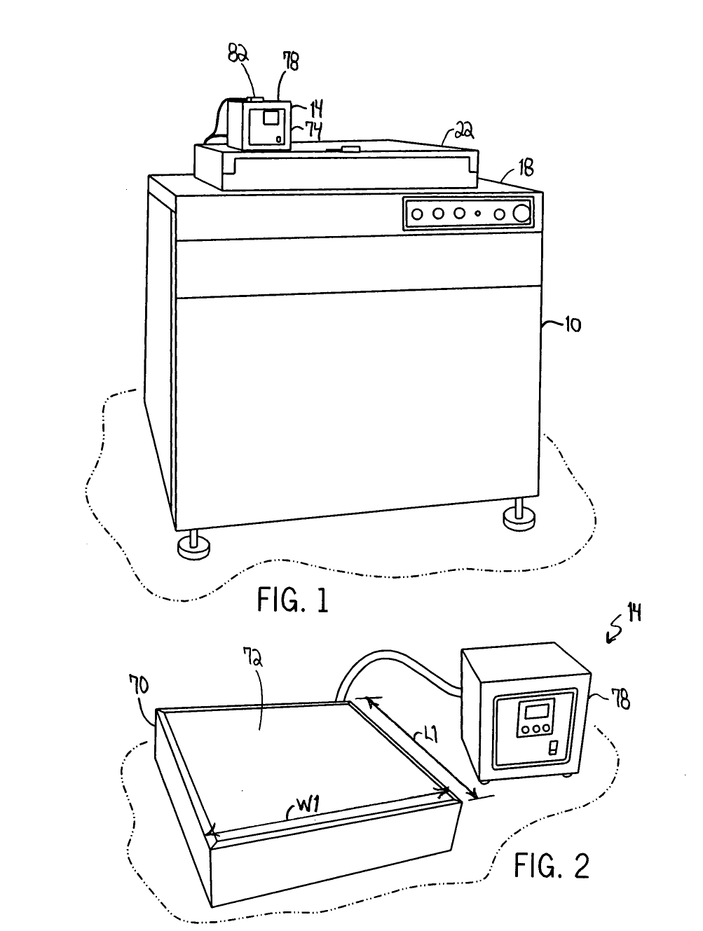

FIG. 1 illustrates a select solder machine 10 and a heater assembly 14 that is used with the select solder machine 10. The select solder machine 10 may be any suitable select solder machine. For example, in one construction, the select solder machine 10 is a JADE S200 select solder machine available from Pillarhouse International, Ltd.

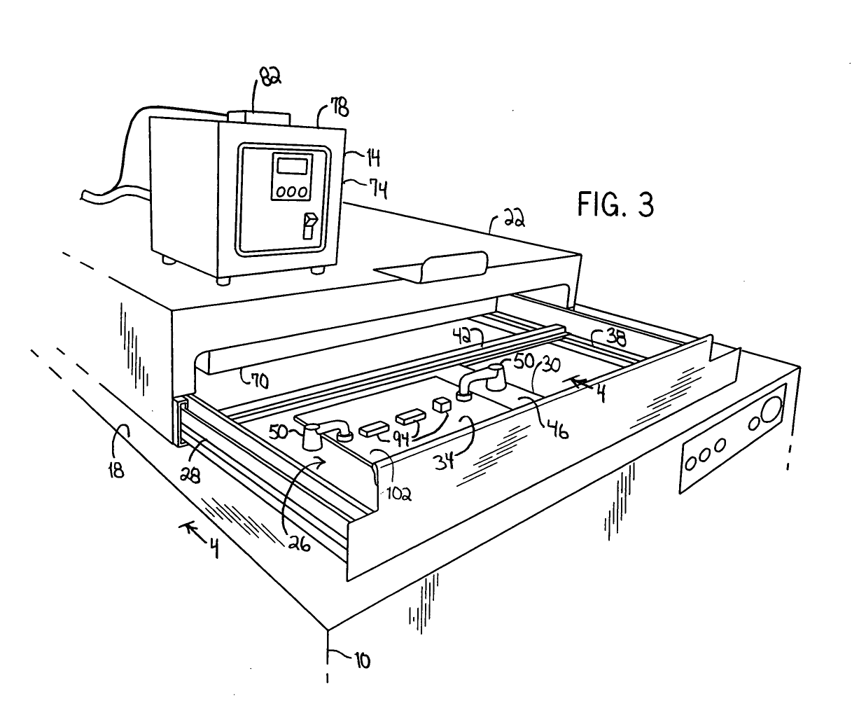

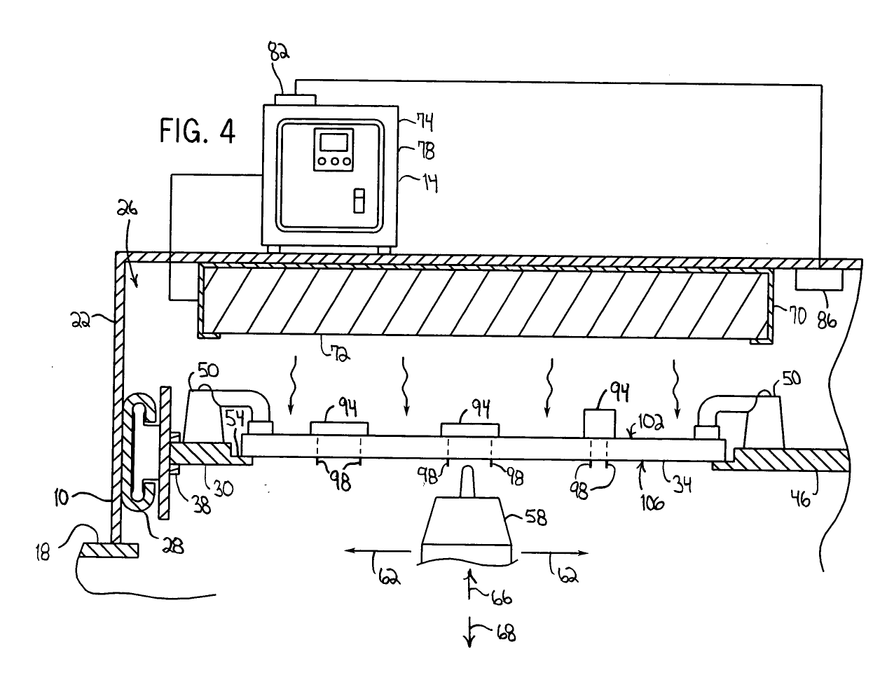

Referring to FIGS. 1 and 3, the illustrated select solder machine 10 includes a housing 18 and a cover 22 that together define a solder chamber 26 (see FIG. 4). The cover 22 is coupled to the housing 18 using slides or rails 28 such that cover 22 is movable with respect to the housing 18 between an open position (FIG. 3) and a closed position (FIG. 1).

Referring to FIGS. 3 and 4, the select solder machine 10 further includes a circuit board support assembly 30 that holds a circuit board 34, such as a printed wiring board (PWB), in a fixed position with respect to the housing 18. In the illustrated construction, the circuit board support assembly 30 includes longitudinal rails 38 and a transverse rail 42 that spans between the longitudinal rails 38. The transverse rail 42 can be moved along the longitudinal rails 38 to facilitate supporting circuit boards having different dimensions. As best seen in FIGS. 3 and 4, in the illustrated construction, a base member 46 having clamps 50 is received by the rails 38 and 42. The base 46 defines a recess 54 that receives the circuit board 34, and the clamps 50 are used to couple the circuit board 34 to the base 46 within the recess 54. Accordingly, the circuit board support assembly 30 holds the circuit board 34 in a generally fixed position with respect to the housing 18.

With continued reference to FIG. 4, the select solder machine 10 further includes a solder head 58. As would be understood by one of skill in the art, the solder head 58 is in fluid communication with a solder bath that holds molten solder material used for soldering the circuit board 34. Also, as would be understood by one of skill in the art, the solder head 58 is movable in horizontal directions (e.g., the direction of arrow 62) and vertical directions (e.g., the direction of arrows 66 and 68) to position the solder head 58 with respect to the circuit board 34. A controller, such as a PLC or a computer, is used to control the movement of the solder head 58. A pump or other suitable device is used to transport the molten solder material from the solder bath through the solder head 58 to create a flow or stream of solder that exits the solder head 58.

Referring to FIGS. 3 and 4, the heater assembly 14 includes a heating member 70 and a controller 74. The controller 74 includes a main heater controller 78 and an over-temperature controller 82. A temperature sensor 86 is electrically coupled to the over-temperature controller 82, and the sensor 86 is located within the solder chamber 26. The sensor 86 can be any suitable temperature sensor, such as a thermocouple, thermistor, resistance temperature detector (RTD), etc.

Referring to FIG. 2, the heating member 70 is a radiant or infrared panel heater having a radiant surface 72 that has a length L1 and a width W1. In one construction, the length L1 is approximately 18 inches and the width W1 is approximately 18 inches. In other constructions, the radiant surface 72 can have other suitable dimensions. The heating member 70 is electrically coupled to the main controller 78, which controls the operation of the heating member 70. In one construction, the main controller 78 and the heating member 70 can be a Model PMX 1212 heater available from Wenseco, Inc. of Chicago, Ill. In other constructions, other suitable heater controllers and heating members can be used.

Referring to FIGS. 3 and 4, the heating member 70 is coupled to the cover 22 such that the heating member 70 is located above the circuit board 34 and the circuit board support assembly 30. Also, the heating member 70 is coupled to the cover 22 such that the radiant surface 72 faces downwardly toward the circuit board 34. In the illustrated construction, the main heater controller 78 is coupled to the top of the cover 22 to facilitate access to the controller 78 by the user of the solder machine 10 (see FIG. 1). Of course, in other constructions, the controller 78 can be located at any suitable position. As best seen in FIGS. 3 and 4, the over-temperature controller 82 is coupled to the main controller 78. However, in other constructions, the over-temperature controller 82 can be located at any suitable position.

Referring to FIG. 3, in operation, the user opens the cover 22 (illustrated in FIG. 3) and loads the circuit board 34 into the solder machine 10. Referring to FIG. 4, in the illustrated construction, the circuit board 34 is loaded into the soldering machine 10 by placing the circuit board 34 into the recess 54 of the base member 46. The clamps 50 are then used to hold the circuit board 34 in a fixed position with respect to the base member 46. It should be understood that just one possible size circuit board 34 is illustrated in the figures. In other constructions or operations of the solder machine 10, the circuit board may have other suitable dimensions. A base member having different dimensions can be used and/or the location of the transverse rail 42 can be adjusted when circuit boards having dimensions different than the circuit board 34 illustrated in FIGS. 3 and 4 are used.

Referring to FIG. 4, the illustrated circuit board 34 includes a plurality of electronic components 94 having leads 98 that extend through the circuit board 34. The leads 98 extend from a top surface 102 of the circuit board 34 and past a bottom surface 106 of the circuit board 34. As would be understood by one of skill in the art, the leads 98 of throughput components such as transistors are soldered into the circuit board to facilitate operation of the circuit board 34.

After the circuit board 34 is loaded into the solder machine 10, but before the circuit board 34 is soldered, the circuit board 34 is preheated using the heater assembly 14. Heating the entire circuit board 34 prior to and during soldering guards against thermal shock from the molten solder material, activates flux, and increases wetting of the solder material to the solder joint. Heating the entire circuit board is superior to only heating the portion of the circuit board adjacent the select solder head in reducing such thermal shock to the circuit board. The heater assembly 14 can thoroughly and uniformly heat the circuit board 34 before soldering and during soldering to guard against thermal shock from the solder material. Also, modern printed wiring boards are often relatively thick and have multiple internal copper layers. The heater assembly 14 is able to thoroughly heat such thick or layered boards to guard against shock, activate flux, and increase wetting of the solder material to the solder joints.

The user heats the circuit board 34 by inputting a first or set point temperature into the main heater controller 78. Alternatively, or in addition to inputting the first temperature, the user may input a heat time value or soak time into the controller 78. In some embodiments, no heat time is required. After either the heat time or the first temperature is entered, the controller 78 activates or turns ON the heating member 70 by increasing the amount of electrical power supplied to the heating member 70. In the illustrated construction, the heating member 70 produces infrared radiation that preheats the circuit board 34, which is typically at ambient temperature when it is loaded into the solder machine 10.

After the circuit board is heated to a desired temperature or for a desired time (or both) the solder machine 10, using the solder head 58, solders the leads 98 of the electronic components 94. As would be understood by one of skill in the art, and while the heater remains ON (but optionally at a different set point temperature or time duration) the solder machine 10 creates a wave or flow of molten solder material that flows from the solder head 58. The solder head 58 moves in the directions of the arrows 62 to position the head beneath one of the leads 98. Then, the solder head 58 moves upwardly in the direction of arrow 66 in order to place the lead 98 in the wave of the solder material to solder the lead 98 into the circuit board 34. The location of the leads 98 can be programmed into a controller, computer, etc., which controls the movement of the solder head 58 such that only select portions of the circuit board 34 are soldered. Meanwhile, as the circuit board 34 is being soldered, the heater assembly 14 can be used to heat the circuit board 34. Alternatively, the heater controller 78 can turn the heating member 70 to an OFF position, or the set point temperature can be lowered to a second temperature, by reducing the amount of electrical power being supplied to the heating member 70 when the circuit board 34 is being soldered.

Referring to FIG. 4, the over-temperature controller 82 and the temperature sensor 86 are used to prevent the temperature within the solder chamber 26 from exceeding a maximum temperature set point. The maximum temperature set point can be determined based upon a temperature that may cause damage to the electronic components 94, circuit board and machine components. The user can either input the maximum temperature set point using the controller 82, or the over-temperature controller 82 can have a pre-programmed maximum temperature set point (i.e., a default). During operation of the solder machine 10, the sensor 86 and controller 82 determine the temperature within the solder chamber 26. If the temperature within the solder chamber 26 exceeds the maximum temperature set point, the controller 82 signals the main controller 78 to either reduce the output of the heating member 70 or turn the heating member 70 to the OFF position.

Various features and advantages of the invention are set forth in the following claims.

What is claimed is:

1. A select solder machine configured to solder a circuit board using a solder material, the select solder machine comprising:
a solder head movable with respect to the circuit board, the solder head configured to position the solder material with respect to the circuit board to solder the circuit board;
a support member configured to support the circuit board in a position adjacent the solder head; and
a heating member configured to heat the circuit board, the heating member located above the circuit board.

2. The select solder machine of claim 1, wherein the heating member includes a radiant panel heater.

3. The select solder machine of claim 2, wherein the radiant panel includes a radiant surface that faces toward the circuit board when the circuit board is supported by the support member.

4. The select solder machine of claim 1, further comprising a cover configured to move between an open position and a closed position to facilitate and inhibit access to the support member, and wherein the heating member is directly coupled to the cover.

5. The select solder machine of claim 1, further comprising a controller configured to control the output of the heating member, and wherein the controller is configured to regulate the output of the heating member based on a set point temperature.

6. The select solder machine of claim 1, further comprising a controller operable to control the output of the heating member, wherein the solder machine has a soldering chamber, wherein the support member supports the circuit board within the soldering chamber, wherein the controller further includes a sensor located within the soldering chamber configured to sense a temperature within the soldering chamber, and wherein the controller is configured to reduce an amount of power being supplied to the heating member in response to the sensed temperature within the soldering chamber being equal to or greater than a set point temperature.

7. The select solder machine of claim 1, wherein the circuit board support member includes a clamp configured to hold the circuit board in a generally fixed position with respect to the heating member.

8. The select solder machine of claim 1, further comprising a controller configured to increase and decrease an amount of power being supplied to the heating member, wherein the controller is configured to receive an input time value and to increase the amount of power supplied to the heating member based on the input time value.

9. The select solder machine of claim 1, wherein the support member is configured to support the circuit board in a position above the solder head.

10. A select solder machine configured to solder a circuit board using a solder material, the select solder machine comprising:
a housing;
a circuit board support member configured to support the circuit board in a generally fixed position with respect to the housing;
a solder head located below the position of the circuit board; and
a heating member configured to heat the circuit board, the heating member located above the position of the circuit board.

11. The select solder machine of claim 10, wherein the solder head is configured to move with respect to the housing, and wherein the solder head is configured to position the solder material with respect to the circuit board to solder the circuit board.

12. The select solder machine of claim 10, wherein the circuit board support member includes a clamp configured to hold the circuit board in the generally fixed position with respect to the housing.

13. The select solder machine of claim 10, wherein the heating member includes a radiant panel heater.

14. The select solder machine of claim 10, further comprising a cover configured to move between an open position and a closed position to facilitate and inhibit access to the support member, and wherein the heating member is directly coupled to the cover.

15. The select solder machine of claim 10, further comprising a controller configured to control the output of the heating member, and wherein the controller is configured to regulate the output of the heating member based on a set point temperature.

16. The select solder machine of claim 15, wherein the solder machine has a soldering chamber, wherein the support member supports the circuit board within the soldering chamber, wherein the controller further includes a sensor located within the soldering chamber configured to sense a temperature within the soldering chamber, and wherein the controller is configured to reduce an amount of power being supplied to the heating member in response to the sensed temperature within the soldering chamber being equal to or greater than a set point temperature.

17. The select solder machine of claim 16, wherein the controller is configured to receive an input time value and to increase the amount of power supplied to the heating member based on the input time value.

18. A method of soldering a circuit board using a select solder machine, comprising:
providing a support member configured to support a circuit board during select soldering;
providing a heating member above the support member;
providing a select solder head beneath the support member;
positioning a circuit board on said support member;
heating the circuit board from above the circuit board using said heating member to a temperature before soldering begins;
moving the select solder head below the circuit board; and
soldering said circuit board using said select solder head.

19. The method of claim 18, further comprising:
continuing to heat the circuit board from above the circuit board at second temperature using said heating element while soldering said circuit board.

20. The method of claim 18, further comprising:
providing a controller that controls the output of said heating element; and
inputting at least one of said first temperature and a time duration into said controller.

21. The method of claim 20, further comprising:
inputting at least one of said second temperature and a second time duration into said controller.

22. The method of claim 21, wherein said first temperature and said second temperature are the same.

23. The method of claim 18, further comprising:
reducing the power to said heating element before soldering said circuit board.

24. The method of claim 18, further comprising:
providing a temperature sensor;
providing a maximum temperature; and
reducing power to said heating element if said temperature sensor senses a temperature that exceeds said maximum temperature.

25. The method of claim 18, wherein said heating step includes the act of heating the entire circuit board.

26. A heater for use with a select solder machine, the select solder machine configured to solder a circuit board, the heater comprising:
a heating element configured to be disposed above the circuit board during soldering of the circuit board;
a sensor configured to sense a temperature and to output a signal indicative of the sensed temperature; and
a controller configured to control the output of the heating element in response to the sensor output signal.

27. The heater of claim 26, wherein the heating element includes a radiant panel heating element.

28. The heater of claim 26, wherein the heating element is configured to be attached to a cover of the select solder machine.

29. The heater of claim 26, wherein the controller is configured to control the output of the heating element both before and during soldering of the circuit board.

30. The heater of claim 26, wherein the controller is configured to receive an input time value, and to increase the amount of power supplied to the heating element based upon the input time value.

31. The heater of claim 26, wherein the controller is configured to regulate the output of the heating member based on a set point temperature.
